(19) United States
(12) Patent Application Publication
(10) Pub. No.: US 2014/0200974 A1
(43) Pub. Date: Jul. 17, 2014

(54) INCREASING SOCIAL ENGAGEMENT WITH REAL-WORLD EVENTS

(71) Applicant: Social Rewards, Inc., Torrance, CA (US)

(72) Inventors: Joseph Morin, Irvine, CA (US); Tatsuo Mike Uesugi, Rancho Palos Verdes, CA (US)

(73) Assignee: Social Rewards, Inc., Torrance, CA (US)

(21) Appl. No.: 13/743,141

(22) Filed: Jan. 16, 2013

(51) Int. Cl. G06Q 30/02; G06Q 50/00

(52) U.S. Cl. CPC G06Q 30/0217; G06Q 50/01
USPC 705/14.19; 705/14.35; 709/206

(57) ABSTRACT

A social engagement display controller controls the display of additional information about an event on displays that are located at the site of the event or at other locations where there is interest in the event. A social engagement server generates check-in codes displayed by the social engagement display controller on the various displays. Upon entry of a check-in code by a user, the social engagement server validates the check-in code to verify with high probability that the user is actually present at the event. Once checked in, the user may provide commentary on or otherwise interact with the event using social networking services, e.g., by posting a message responding to the additional information about the event displayed on the displays. The social engagement server may credit the user for the event commentary.

### BACKGROUND

1. Field of Art

The present invention generally relates to the stimulation of conversations about events or other topics via social networking services.

2. Background

Businesses and other organizations typically wish to understand the characteristics of their customers or potential customers in order to provide more appealing goods and services. In some contexts, such information is readily available. For example, online shoppers who make purchases after previously logging into an account are inherently associated with their account information, such as their age, gender, interests, and whatever other data the account tracks.

In many other contexts, however, the audience is essentially anonymous. For example, when a moviegoer or other event attendee purchases a ticket with cash, or even with a credit card, the organizations associated with the event—such as a movie theater that shows a film, or the production studio that produces the film—have no knowledge of the identities or interests of the attendees. Consequently, such organizations cannot easily obtain the audience information that would allow them to more effectively tailor their offerings to their audience.

### BRIEF SUMMARY

In one embodiment, a social engagement display controller controls the display of additional information about an event on displays that are located at the site of the event or at other locations where there is interest in the event. A social engagement server generates check-in codes displayed by the social engagement display controller on the various displays. Upon entry of a check-in code by a user, the social engagement server validates the check-in code to verify with high probability that the user is actually present at the event. Once checked in, the user may provide commentary on or otherwise interact with the event using social networking services, e.g., by posting a message responding to the additional information about the event displayed on the displays. The social engagement server may credit the user for the event commentary.

### BRIEF DESCRIPTION OF DRAWINGS

FIG. 1 is a block diagram of a computing environment, according to one embodiment.

FIG. 2 is a high-level block diagram illustrating physical components of a computer used in the computing environment of FIG. 1, according to one embodiment.

FIGS. 3A-3C illustrate various sample user interfaces that provide examples of the operations of the various components of FIG. 1 in the context of attendance at a movie showing, according to one embodiment.

FIG. 3 is a high-level block diagram illustrating a detailed view of the social engagement display controller of FIG. 1, according to one embodiment.

FIG. 4 is a high-level block diagram illustrating a detailed view of the social engagement display controller of FIG. 1, according to one embodiment.

FIG. 5 is a high-level block diagram illustrating a detailed view of the social engagement server of FIG. 1, according to one embodiment.

FIG. 6 is an event trace diagram illustrating interactions of the various components of

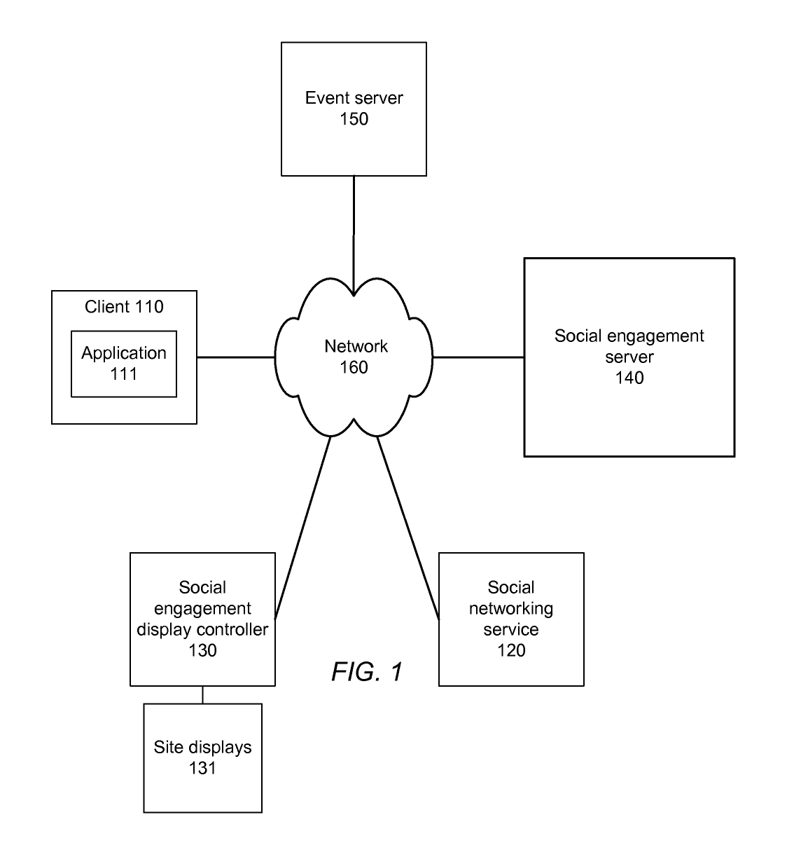

FIG. 1, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

FIG. 1 is a block diagram of a computing environment, according to one embodiment. Consumers carry client devices 110 such as smart phones when attending real-world events such as movie showings and live concerts, and the like, or when visiting locations such as restaurants and bars. A remote social engagement server 140, and a social engagement display controller 130 which may be located at the event site, together facilitate increasing social engagement of consumers with the events, including promoting interaction with displays 131 located at event sites. Additionally, the increased social engagement, coupled with functionality such as validated consumer check-in at event sites, permits learning a great deal about the interests and other characteristics of the consumers at the events, many of whom would otherwise be anonymous. The various components of the computing environment are now described in more detail.

Client devices 110 are computing devices used by consumers (hereinafter referred to as “users”) that execute client software, e.g., a web browser or built-in client application, to perform actions such as interacting with social networking services 120. The client device 110 might be, for example, a smart phone or tablet computer using the IOS, ANDROID, or WINDOWS PHONE operating systems, a personal digital assistant, or an ultrabook or other laptop computer. The client devices 110 may interact with social networking services 120 using a browser or using custom applications designed for use with the services. The client devices 110 may have hardware and software to allow the devices to obtain location information identifying their current geographic locations, such as via global positioning service (GPS) or cellular tower triangulation.

The client device 110 includes an application 111, such as a web browser or a custom social engagement application provided by the social engagement server 140, that the user uses to view and interact with additional content related to an event that the user is attending. For example, in the context of movie events the application 111 could display information about a movie preview currently being displayed at a movie theater, questions related to the actors for scenes in the previews, and the like.

The social networking services 120 provide users with the ability to share information—such as comments, opinions, real-time messages, images, files, and the like—with other users, such as those within user-defined social circles. Examples of social networking services 120 include FACEBOOK, TWITTER, MYSPACE, GOOGLE PLUS, PINTEREST, and the like.

An optional event server 150 provides information about events, such as the times and places that the events take place. For example, in the case of movie showings provided by movie theater companies, each movie theater company (e.g., AMC ENTERTAINMENT, REGAL ENTERTAINMENT GROUP, or CINEMARK THEATRES) may provide its own event server 150 specifying at least the day, time and location (e.g., IP address, theater street address, and/or screen number) of each movie being shown.

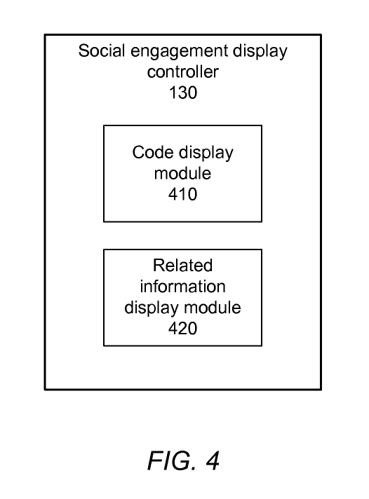

The social engagement server 140 performs a number of functions, such as handling user login to a social rewards system, verifying user event attendance with check-in codes (e.g., using event information provided by an event server 150), rewarding the user for event-related social activity performed on social networking services 120, and the like. The social engagement server 140 is described in more detail below with respect to FIG. 4.

The social engagement display controller 130 controls display of event-related information on displays 131 located at the event site or other location, stimulating users to use their client devices 110 to comment on or otherwise relate to the events. Event sites include movie theaters, concert halls, sports stadiums, restaurants, bars, or any other location to which users go for an event of interest. The event sites also include one or more displays 131 on which information can be shown, such as movie theater screens or lobby video screens at a theater multiplex, video screens at a sports stadium or museum, and the like. In some embodiments, each event site has one or more social engagement display controllers 130 that control display of additional information about the event on the event site displays. In some embodiments, social engagement display controllers 130 may also be located so as to control displays 131 not located at the event site itself, such as displays located at a restaurant but showing commentary from users watching movie pre-show entertainment.

The social engagement display controller 130 may be implemented as custom hardware that directly displays information, such as a projector at a movie theater that displays advertisements, previews, trivia, or the movie itself. Alternatively, the social engagement display controller 130 may not directly display the event-related information, but rather provides the input that allows other devices to display the information, such as providing video frames to video controller hardware via a LAN or WAN, or providing content descriptors (e.g., identifiers of database entries) to a separate intelligent display controller.

Some example deployments of the social engagement display controller 130 are now described. In the context of movie showings at a theater multiplex, for example, in one embodiment each individual movie theater has its own social engagement display controller 130 that acts as a projector and determines which ads, previews, trivia, questions, and the like are displayed before the movie begins. In one embodiment, the social engagement display controller 130 is a hardware add-on to the projector operated by the movie theater. In another embodiment, an entire theater multiplex has a single social engagement display controller 130 that interacts with the movie projectors in each movie theater over a wired or wireless local network to specify what will be displayed on the screen, e.g., by providing the actual video input or instructions or codes identifying the input to be selected from local data stores available to the projectors. In some embodiments, the social engagement display controller 130 is implemented as software rather than hardware and runs, for example, on a media server computer for the entire theater multiplex or on the hardware of the individual theater projectors. Social engagement display controllers 130 may equally be deployed at the event sites for other types of events, controlling information display on, e.g., displays in stadiums, restaurants, bars, or the like.

In one embodiment, the social engagement display controller 130 is not located at the site of the event itself, but rather is part of the social engagement server 140 or other server located remotely with respect to the event site. In such an embodiment, the social engagement display controller 130 remotely instructs display hardware running at the event site about what to display on the site displays 131.

In another embodiment, the social engagement display controller 130 is located at a location other than the event site that has displays 131 to be controlled. In such an embodiment, the social engagement display controllers 130 display information and enable social engagement in the same way as social engagement display controllers located at the event site. In one specific example, social engagement display controllers 130 may be located at a restaurant and control displays 131 located at the restaurant to display additional information about some other event, such as user comments about recent movies that were entered at a movie theater.

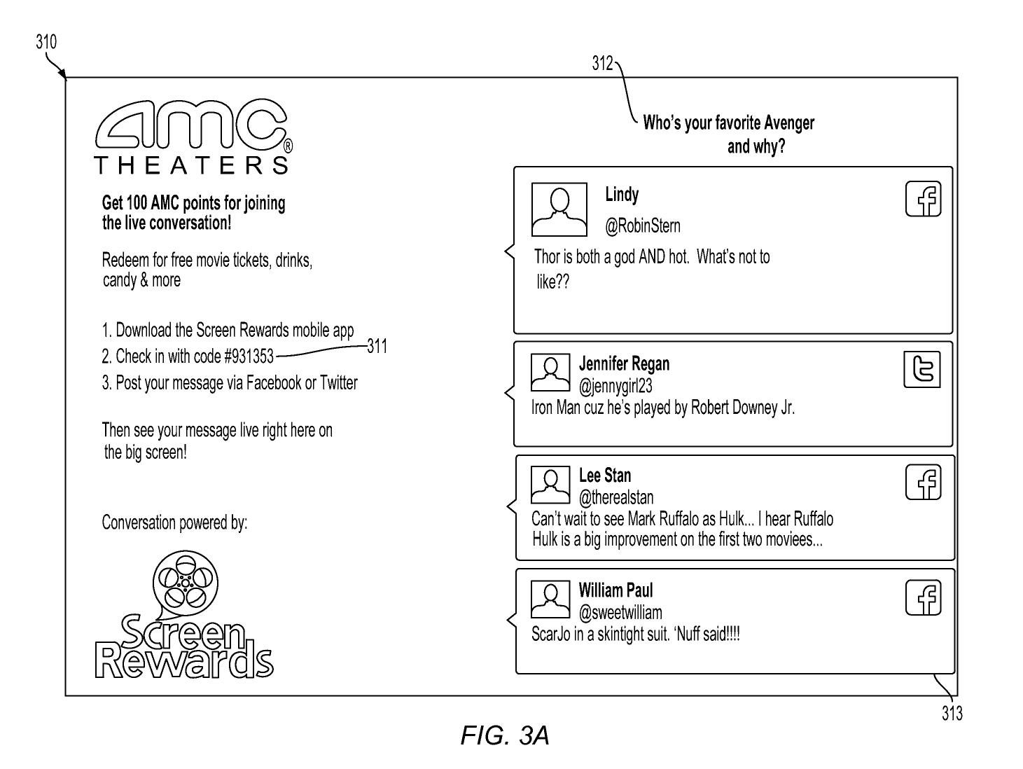

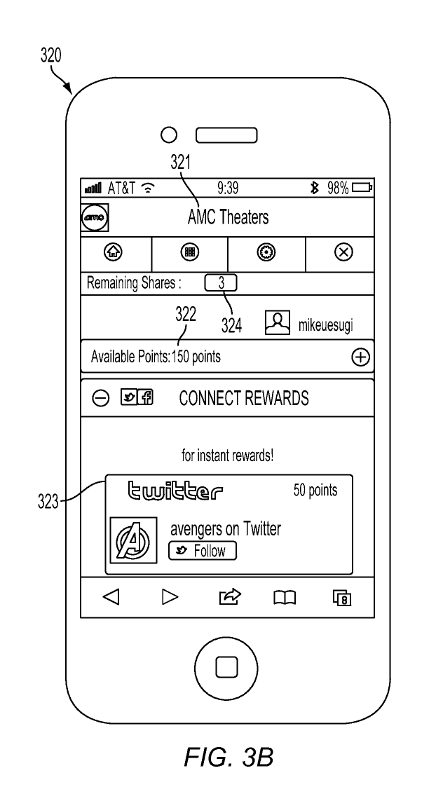

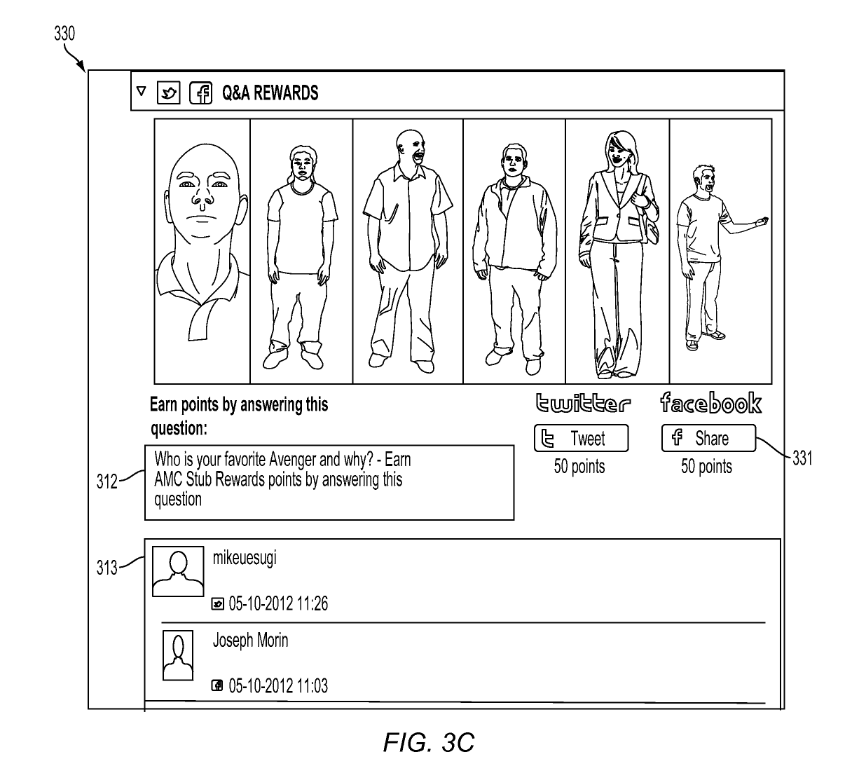

The functionality of the social engagement display controller 130 is described in more detail below with respect to FIG. 3.

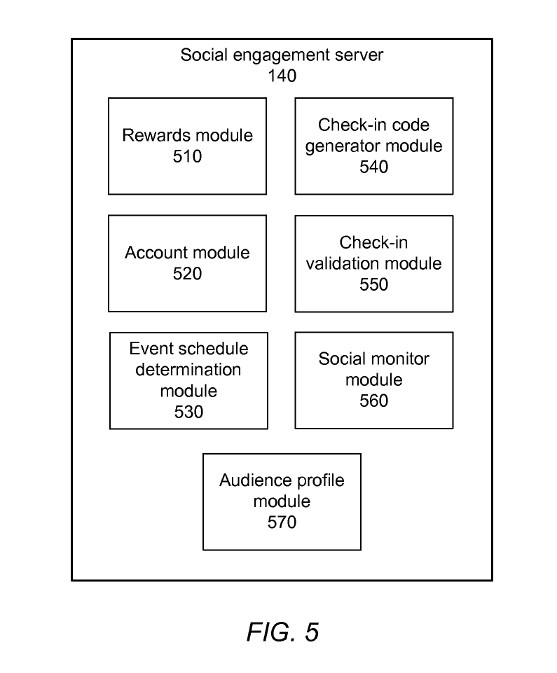

The social engagement display controller 130 and the social engagement server 140, in cooperation with other components of FIG. 1, serve to stimulate discussion of events and event-related concepts or entities across the social networking services 120. This results in additional publicity for the organizations that hold or sponsor the events or that produce content displayed at the events. For example, a discussion of particular movie characters provides additional publicity for the movie studio that produced the movie. Additionally, in some embodiments the social engagement display controller 130 and the social engagement server 140 make user participation in the discussion contingent upon validation that the user is actually present at the event upon which the user is commenting. As discussed in more detail below with respect to FIG. 5, validation of the user's presence at the event involves determining the identity of the user, which in turn allows determining the interests or other characteristics of users at the events, many of whom would otherwise be anonymous (e.g., due to paying in cash). Knowledge of these user characteristics is of value to many organizations associated with the event. For example, knowledge of the users who attend movies—such as the characteristics of the audience that attends an opening weekend showing of the movie—is of particular interest to the studios that produce the movies, who might alter their marketing or movie distribution to account for characteristics of their audiences.

The various components of FIG. 1 may communicate via a network 160, such as the Internet. As noted, certain components may alternatively and/or additionally communicate over a local area network, such as a social engagement display controller 130 physically located at an event site and controlling the local site displays 131 via a wired or wireless LAN.

Although for simplicity FIG. 1 depicts only a single client 110, social networking service 120, social engagement display controller 130, social engagement server 140, and event server 150, it is appreciated that there could be any number of each. For example, every user may have one or more clients 110. An event server 150 may or may not be supplied by any given organization holding events. As described above, there may be multiple social engagement display controllers 130 at any given event site, or there may be one or more global social engagement display controllers communication with displays 131 over the network 160. There also may be multiple distinct social networking services 120. A given event site may also have multiple site displays 131, such as a screen in every theater of a multiplex in addition to screens in the multiplex lobby, multiple synchronized displays in different portions of a sports stadium, and the like.

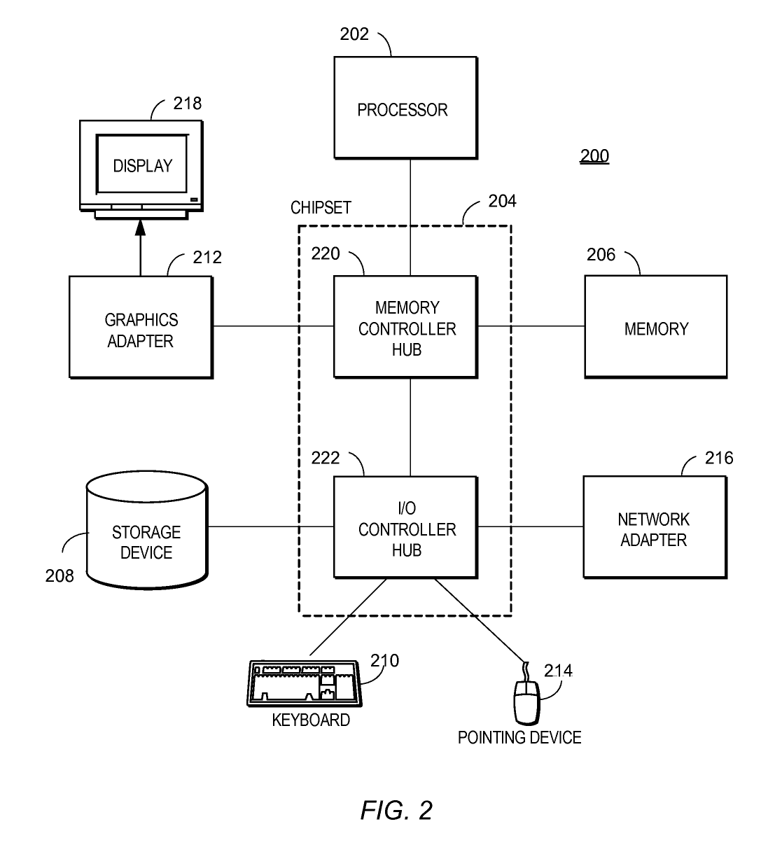

FIG. 2 is a high-level block diagram illustrating physical components of a computer 200 used as part or all of the client 110, social networking service 120, social engagement display controller 130, social engagement server 140, or event server 150 from FIG. 1, according to one embodiment. Illustrated are at least one processor 202 coupled to a chipset 204. Also coupled to the chipset 204 are a memory 206, a storage device 208, a keyboard 210, a graphics adapter 212, a pointing device 214, and a network adapter 216. A display 218 is coupled to the graphics adapter 212. In one embodiment, the functionality of the chipset 204 is provided by a memory controller hub will 220 and an I/O controller hub 222. In another embodiment, the memory 206 is coupled directly to the processor 202 instead of the chipset 204.

The storage device 208 is any non-transitory computer-readable storage medium, such as a hard drive, compact disk read-only memory (CD-ROM), DVD, or a solid-state memory device. The memory 206 holds instructions and data used by the processor 202. The pointing device 214 may be a mouse, track ball, or other type of pointing device, and is used in combination with the keyboard 210 to input data into the computer 200. The graphics adapter 212 displays images and other information on the display 218. The network adapter 216 couples the computer system 200 to a local or wide area network.

As is known in the art, a computer 200 can have different and/or other components than those shown in FIG. 2. In addition, the computer 200 can lack certain illustrated components. In one embodiment, a computer 200 acting as a server may lack a keyboard 210, pointing device 214, graphics adapter 212, and/or display 218. Moreover, the storage device 208 can be local and/or remote from the computer 200 (such as embodied within a storage area network (SAN)).

As is known in the art, the computer 200 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 208, loaded into the memory 206, and executed by the processor 202.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience. Further, it is appreciated that not all the components illustrated in FIG. 2 need be present in the various systems 110, 120, 130, 140, or 150. For example, for an embodiment in which the client 110 is a smart phone, the client will rarely have a separate keyboard 210 or pointing device 214.

FIGS. 3A-3C illustrate various sample user interfaces that provide examples of the operations of the various components of FIG. 1 in the context of attendance at a movie showing, according to one embodiment.

FIG. 3A illustrates a user interface 310 produced by a social engagement display controller 130 for display at a movie theater before the showing of the featured movie, according to one embodiment. The user interface 310 includes instructions that explain to a user how to use the client device 110 to participate socially in the movie event. In particular, the instructions include a check-in code 311 that users can enter into the application 111 of the users' client devices 110 to join in a conversation about the event (e.g., the 6-digit code “931353” illustrated in FIG. 3A). The user interface 310 of FIG. 3 also includes a discussion topic question 312 related to the event (e.g., a question about a favorite character in the featured movie or a related movie) to which the users can respond using their application 111 once they have checked in using the check-in code 311. For example, area 313 displays four responses to the discussion question 312 posted by users via various social networking services 120. The area 313 is updated in real time to include the most recent user responses of the users in the movie theater (i.e., at that specific movie event), or at any of the showings of that same movie at other locations (i.e., at other related events). The social engagement display controller 130 need not display discussion topic questions 312 and answers 313, but alternatively or additionally may display any sort of content that may be used to stimulate discussion. For example, in other embodiments the social engagement display controller 130 displays a live video feed of a celebrity (e.g., an actor associated with the featured movie) answering live questions posted by users. The users may (after entering the check-in code) enter questions directed to the celebrity, which the social engagement display controller 130 then displays along with the video feed of the celebrity answering the questions.

FIG. 3B illustrates a user interface 320 produced by the application 111 of the client device 110 that appears once the user has checked in at the movie event using the check-in code 311 of FIG. 3A, according to one embodiment. The user interface 320 displays the location 321 of the event for which the user has checked in, as well as an amount of credit that the user has available based on the user's prior use of the social engagement functionality provided by the application 111. The user interface 320 further provides user-interface elements 323 listing entities related to the current movie event and simplifying the process of socially commenting on or sharing those entities, such as expressing approval for the entities or submitting a post about the entities. In one embodiment, the number of comments/shares for which a user can receive credit is limited to a maximum number within a given period, such as three per day. This serves to restrict a user to commenting or sharing judiciously.

FIG. 3C illustrates a second user interface 330 produced by the application 111 of the client device 110 that appears once the user has checked in at the movie event using the check-in code 311 of FIG. 3A, according to one embodiment. The user interface 330 includes the same discussion question 312 shown in FIG. 3A and also includes an area 313 showing real-time comments from other users. The user interface 330 additionally includes user interface elements 331 that lead to user interfaces for responding to the question via various social networking services 120. When the user responds, the response is posted on the social networking services 120, and also appears in real time within user interface of the application 111, such as area 313. (The response may appear either directly by communication between the application 111 and a local social engagement display device 130, or indirectly by the application querying the social networking services 120 for new postings by the users who have checked in to the given movie event.) Similarly, in embodiments or situations in which a celebrity is addressing live questions, the area 312 could alternatively display a prompt for entering a question (such as “Enter any questions that you have for Brad”), along with the user interface elements 331 for posting the question, and the area 313 could display questions entered by other movie theater patrons using the same user interface 330.

The various components of the social engagement display controller 130 and the social engagement server 140 that enable the user interfaces of FIGS. 3A-3C are now described.

FIG. 4 is a high-level block diagram illustrating a detailed view of the social engagement display controller 130 of FIG. 1, according to one embodiment. As described above with respect to FIG. 1, the social engagement display controller 130 controls the display of information on displays 131 located at event sites or other locations, such as the example movie screen of FIG. 3A described above.

The social engagement display controller 130 comprises a code display module 410 that displays the check-in code—referenced in FIG. 3A above—that a user may use to check in with the social engagement server 140 to verify that the user was actually present at the associated event. The generation of the check-in code is described in more detail below with reference to FIG. 5.

The social engagement display controller 130 further comprises a related information display module 420 that identifies information with some relationship to the current event and displays that information on the event site displays 131. The related information may be of any type calculated to stimulate additional discussion of and engagement with the current event via the social networking services 120. For example, the related information may be the discussion question 312 or the user responses 313 thereto, as illustrated in FIG. 3A. The social engagement display controller 130 may obtain the related information in different manners, depending on the embodiment and on the type of related information. In one embodiment, all of the related information is obtained from the social engagement server 140. For example, the social engagement server 140 can maintain a list of questions 312 associated with the different events and generated either by the organization responsible for the social engagement server or by clients thereof, who submit the questions for storage on the social engagement server 140. As another example, the social engagement server 140 can obtain the responses 313 by querying the social networks 120 for postings by the users who have checked in for the current event by entering the check-in code 311. (The client application 111 can obtain the responses 313 in the same manner.) In another embodiment, the social engagement display controller 130 obtains the related information directly, rather than relying on the social engagement server 140. For example, a local database that is part of or accessible to the social engagement display controller 130 may be directly populated with the questions 312 by the organization hosting the event. Similarly, the social engagement display controller 130 may directly query the social networks 120 for the responses 313.

Using the obtained related information, the social engagement display controller 130 updates the displays 131, such as in FIG. 3A, above.

FIG. 5 is a high-level block diagram illustrating a detailed view of the social engagement server 140 of FIG. 1, according to one embodiment. The social engagement server 140 comprises a number of distinct modules for performing functions related to the consumers who use the client devices 110, including a rewards module 510, an account module 520, and event schedule determination module 530, a check-in code generator module 540 a check-in validation module 550, a social monitor module 560, and an audience profile module 570. These modules are now described in more detail.

The rewards module 510 provides incentives for users to use the social engagement server 140 to comment on or otherwise interact with events. In one embodiment, the rewards module 510 credits the user's account on the social engagement server 140 with credits that the user may redeem to purchase various products or services. Credits may be awarded in response to the user performing various actions. For example, in one embodiment credits are awarded to the user when the user: creates an account with the social engagement server 140; installs a social engagement application 111 provided by the social engagement server on the user's client device 110; checks in with the social engagement server to verify that the user attended a particular event; posts a response 313 to a question 312, as in FIG. 3A; watches an entire video related to an organization that is affiliated with the social engagement server; makes a connection with the organization on a social networking service 120; or replies to or forwards a message related to a product or service of the organization on a social networking service. In one embodiment, a coupon for an instant reward (such as free promotional popcorn at a movie theater) is immediately displayed within the user interface of the application 111 for instant redemption (e.g., at the theater concession stand); after redeeming the coupon (e.g., by a two click redemption process by a concession stand employee), the coupon disappears from the user interface.

In one embodiment, the rewards module 510 waits for some period to credit a user for a posting a message to a social network 120 (such as the responses 313). This serves to prevent a user from obtaining credit for posting a message which the user then removes shortly afterwards. In one such embodiment, the rewards module 510 receives a notification at the time of posting from the application 111 used to post the message. After a lapse of some period of time, such as 24 hours, the rewards module 510 uses the social monitor module 560 to query the social network 120 on which the message was posted, e.g., using the information about the message provided by the application 111 at the time of posting as keywords for the query. If the message is still posted on the social network 120 at this later time, the rewards module 510 credits the user for posting the message. If not, no credit is awarded.

The account module 520 handles tasks related to user accounts, such as account creation and login. In one embodiment, when a user submits an initial request to create an account with the social engagement server 140, the account module 520 determines the type of account that the user may create, or whether or not to permit a user to create an account at all, based on attributes of the user's accounts on the social networking service(s) 120. In one embodiment, the account module 520 examines a number of different parameters related to the social networking service(s) 120, including: the number of distinct social networking services 120 on which the user has an account; the length of time since accounts on the service(s) were established; the number of people (e.g., friends on FACEBOOK, or followers on TWITTER) in the user's social network(s), as well properties of those people (e.g., a score quantifying their degree of influence on other users, or a determination of whether they are members of particular desirable or undesirable groups). Such parameter examination allows the account module 520 to distinguish users with a genuine social presence from those who are merely creating an account to obtain the credits provided by the rewards module 510 and, if necessary, to deny accounts to the latter.

In one embodiment, the account module 520 requests or requires access to the user's accounts on the social networking services 120 as part of the account creation process. Once the account module 520 has obtained access to the accounts, it can assess the parameters mentioned above (e.g., determine the length of time since the accounts were established) to determine what type of account the user may create, if any. Obtaining account access enables other functionality, as well, such as querying the various social networks 124 for the user responses 313, as described above.

In one embodiment, as part of user account creation the account module 520 requests demographic information from the user. This demographic information, as well as any information publicly available about the user via the user's accounts on the social networking services 120, provides useful information about the types of users that are interested in particular events.

The event schedule determination module 530 stores information related to real-world events, such as the days, times, durations, and locations of the different possible events. (Events can be stored at any level of granularity. For example, a movie showing—including pre-movie advertisements, previews, and the featured movie itself—may be stored as a single event. Alternatively, each portion may be considered as a separate event and have a separate check-in code, so that a user could (for example) check-in separately to the previews portion of a movie and to the featured movie.) In one embodiment, the event schedule determination module 530 dynamically obtains the event information by communicating with the event servers 150. For example, in one such embodiment the event schedule determination module 530 maintains a list of all the event providers for which it provides social engagement services (e.g., companies operating movie theater complexes) and periodically communicates with their respective event servers 150 to obtain event information. The communication may take different forms in different embodiments, such as calling an event schedule API of the event provider, or parsing and analyzing web pages provided either directly by the event provider or indirectly by some third-party service (e.g., a movie showtimes service listing all the movies playing at given places and times).

The event location information may differ in different embodiments. For example, the event location information may vary in its degree of granularity, ranging from relatively precise location information (e.g., GPS coordinates), to less precise information such as a street address, to relatively coarse information such as zip code.

The check-in code generator module 540 generates and disseminates codes that are used to verify user attendance at events. Specifically, for every event (e.g., movie showing) tracked by the social engagement server 140, the check-in code generator module 540 generates a check-in code corresponding to that event. The check-in code generator module 540 additionally determines a validity period during which the code is valid, based on the event day/time and duration information provided by the event schedule determination module 530, and associates the validity period with the generated code. The check-in code generator module 540 then distributes the check-in code (along with its associated validity period) to the social engagement display controller 130 associated with the event, which displays the check-in code on one or more of the site displays 131 that it controls.

The check-in code generator module 540 can generate new codes for the same event after the expiration of the validity period for the prior code. By generating multiple codes and multiple corresponding validity periods for the same event (e.g., a new code every five minutes), the check-in code generator module 540 makes it more difficult for a user not actually attending the event to check in with the code, particularly if the validity periods are sufficiently short. In one embodiment, the check-in code generator module 540 generates all the check-in codes before the event and transmits them, along with indications of their corresponding validity periods, to the social engagement display controller(s) 130 associated with the event. In other embodiments, the check-in code generator module 540 generates and sends check-in codes and their corresponding validity periods only as needed, sending the first code shortly before the beginning of the first code's validity period, and sending the next code shortly before the beginning of the second code's validity period, and so on.

As a specific example, assume that the event schedule determination module 530 indicates that a particular movie is playing at 3:45 PM on Oct. 1, 2012 until 5:45 PM, that previews will be displayed from 3:25 PM to 3:45 PM, and that the IP address of a social engagement display controller 130 controlling the projector for the movie is 152.168.2.7. Further assume that the check-in code generator module 540 generates codes having validity periods of five minutes' duration, and that the check-in codes are only to be displayed during the previews. In such a case, the check-in code generator module 540 might randomly generate four distinct check-in codes, each corresponding respectively to the five-minute periods 3:25 PM to 3:30 PM, 3:30 PM to 3:35 PM, 3:35 PM to 3:40 PM, and 3:40 PM to 3:45 PM, and send the codes (along with indications of the periods to which they correspond) to the social engagement display controller 130 at IP address 152.168.2.7. At the beginning of each new validity period, the social engagement display controller 132 to which the codes were sent would stop displaying the check-in code corresponding to the prior period and would instead begin displaying the check-in code corresponding to the new period.

In one embodiment, the check-in code generator module 540 may also generate codes for a general location not currently hosting a specific event. For example, the check-in code generator module may generate check-in codes for a particular restaurant, rather than for, e.g., a specific event taking place at that restaurant. When generating codes for a general location, the check-in code generator module 540 again generates a code and associates it with the validity period, and generates new codes with corresponding new validity periods after the old validity periods expire, in the same manner as when generating a code for a specific event. However, given that the codes are being generated for a location rather than from an event, the beginning and ending times of an event need not be taken into consideration. Thus, as one specific example, the check-in code generator module 540 could continually generate check-in codes for checking in at a particular restaurant, each check-in code corresponding to one of the 288 distinct five-minute intervals of a given day.

The generated codes may be composed of any number of alphanumeric characters. Alternatively, the generated codes may use a visual pattern or any other technique for identifying an event such that it is improbable that a user could guess a code value that matches a valid event without prior knowledge of the code value displayed on a display 131. Likewise, the validity period may be set to any length of time that is sufficient to prevent others not actually present at the event from obtaining and entering the code. In one embodiment, for example, the code is composed of six randomly-generated numeric digits, and the validity period is five minutes, though it is appreciated that other values could also be used.

It is appreciated that check-in codes could be generated and provided in a manner other than that discussed above. For example, responsibilities can be divided differently between the social engagement display controller 130 and the social engagement server 140 then as discussed above, such as the social engagement display controller 130 generating the codes based on event information obtained from an event server 150 and communicating them to the social engagement server 140.

The check-in validation module 550 verifies that the check-in code sent by a user is valid, and (consequently) that in all probability the user is indeed attending the event. Specifically, the check-in validation module 550 determines whether the check-in code provided via a user's client device 110 matches a code distributed by the check-in code generator module 540 and was sent at a time falling within a corresponding validity period that was active at the time of sending. (A validity period is considered “active” at a given time if the time is at or after the beginning of the validity period and at or before the end of the validity period.) The check-in validation module 550 may accomplish this determination in various ways. In one embodiment, the generated codes and their corresponding validity periods are stored in a hash table and a corresponding hash function is used to map the user-provided code to an index within the hash table. The user-provided code is then considered valid if it is found in the hash table and its corresponding validity period was active at the time that the user sent the code; otherwise, it is considered invalid.

In one embodiment, the check-in validation module 550 additionally takes into account location information (e.g., GPS) when verifying the check-in code. Specifically, if location functionality of the client device 110 is active at the time that the application 111 sends the check-in code to the social engagement server 140, the application includes location information along with the check-in code. Having identified an event associated with the received check-in code, the check-in validation module 550 compares the received location information to the location information for that event as determined by the event schedule determination module 530. If the location information is sufficiently geographically proximate to the known event location information, then the location information is considered to match. In one embodiment, the check-in validation module 550 determines that the check-in code sent by the user is valid only if the check-in code is active for the relevant validity period and the location information matches.

The social monitor module 560 monitors event-related information, such as posted messages, disseminated via the social networking services 120. Specifically, using the access to the user accounts on social networking services 120 that was granted at the time of creation of an account with the account module 520, the social monitor module 560 queries the social networking services for new messages posted by the users. The new messages relevant to the given event may be obtained by filtering the set of all new messages using keywords or identifiers included in the posting by the application 111, for example. Such queries represent one way of obtaining the answer messages displayed in the area 313 of FIG. 3A above, for example.

The audience profile module 570 creates an audience profile comprising characteristics of users attended and/or commented on an event. As noted, many event attendees pay with cash, credit card, or some other payment method that causes them to remain anonymous with respect to organizations such as the event organizer. However, once the check-in validation module 550 has verified a user's identity and that the user was in fact present at a given event or other related location, information about that user, as well as any comments that the user makes about the event using the social networking services 120, can be reliably associated with the event. For example, information about the user within the audience profile for the event can include the user's identity, characteristics that the user specified when creating an account with the social engagement server 140, information of the user's accounts on the social networking services 140 that was made public or otherwise available to the social engagement server 140, and event-specific comments. The aggregate information may be anonymized to protect the identities of the individual users.

The audience profile module 570 may make the assembled audience profile for a given event available to organizations associated with the event, or to other organizations. For example, the audience profile module 570 might provide an anonymized or non-anonymized audience profile of the users who attended opening weekend showings of a particular movie available to the movie studio that created the movie. This allows the movie studio to better understand its audience and adjust its marketing or movie production efforts accordingly.

The statistics in the audience profile may be used to perform analytics. For example, based on a check-in of a user at a showing of a first movie that included a preview for a second, future movie, and based on a check-in of the user at a showing of the second movie, it can be determined that the user saw both a preview and (at a later date) the full movie. A movie studio, for example, might be interested in such analytics data for determining how effective certain previews were at generating a later visit to the full movie. More generally, the statistics allow estimating how presence at a particular event or sub-event (e.g., a preview at a first movie for a second movie), or particular interaction at that event or sub-event (e.g., making a comment during the preview) is at bringing about presence at a different event or sub-event (e.g., the full movie for the earlier preview).

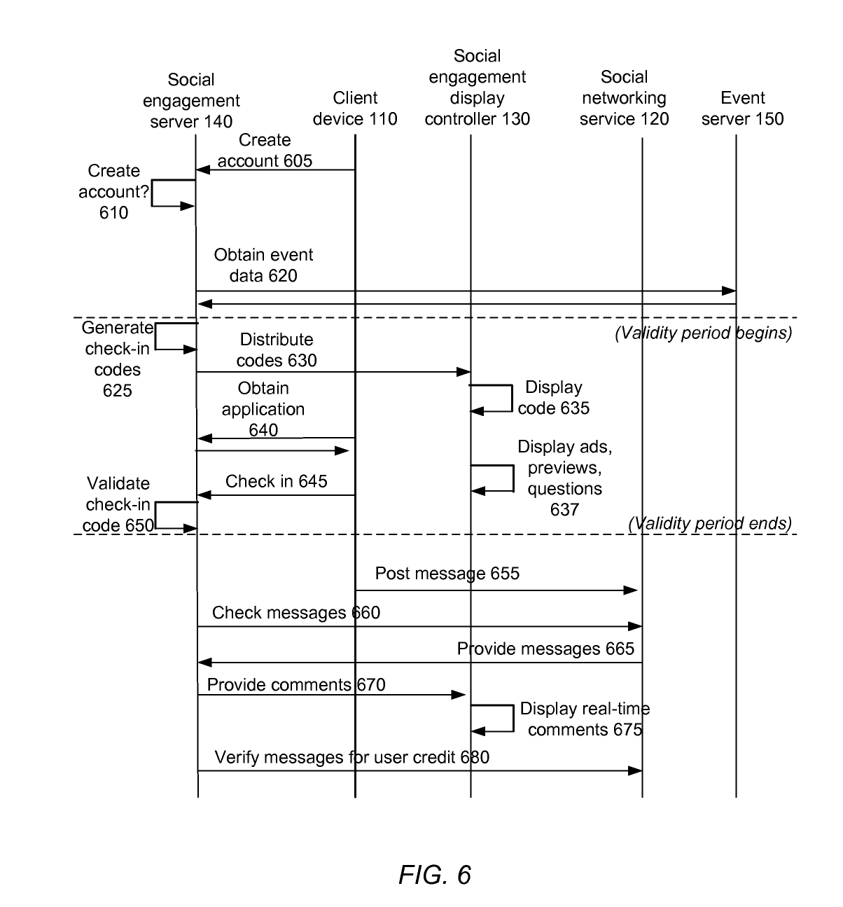

FIG. 6 is an event trace diagram illustrating interactions of the various components of FIG. 1, according to one embodiment. In interaction 605, the user uses the user's client device 110 (or other system, such as a desktop computer) to request the creation of an account with the social engagement server 140. The social engagement server 140 then determines 610 whether to grant the user an account based on characteristics of the users accounts on social networking services 120, as described above with respect to the account module 520.

The social engagement server 140 periodically obtains 620 event information for the events of the various event hosts registered with the social engagement server 140, as described above with respect to the event schedule determination module 530.

The social engagement server generates 625 check-in code(s) for the event and associates them with corresponding validity periods, as described above with respect to the check-in code generator module 540. The social engagement server 140 additionally distributes 630 the check-in code(s) to the particular social engagement display controller 130 that is responsible for the event, and the social engagement display controller displays 635 the check-in code on its associated display devices 131, as described above with respect to the code display module 410. The social engagement display controller 130 may periodically display new check-in codes corresponding to new validity periods, e.g., a new check-in code every five minutes. The social engagement display controller 130 additionally displays 637 other information, such as ads, previews, questions, and the like at appropriate times, such as concurrent with or after the display 635 of the check-in code, as described above with respect to the related information display module 420 of FIG. 4.

In one embodiment, at any point in the process after creating an account, the user may request an application 111 that is designed specifically for creating and interacting with social engagement information (e.g., entering the check-in code, posting responses 313, and the like), and the social engagement server 140 will provide it. The user can then install the application 111 on the client device 110 and use it (rather than, e.g., a standard browser application 111) for social engagement activities.

After seeing the check-in code displayed 635 on the event site displays 131, the user uses the application 111 to enter the check-in code. Accordingly, the social engagement server 140 attempts to validate 650 the check-in code, as described above with respect to the check-in validation module 550.

If the check-in code is validated, the user may use the application 111 on the client device 110 to post 655 messages related to the event using the social networking services 120. The social engagement server 140 periodically checks 660 for messages from users with accounts on the social engagement server 140, as described above with respect to the social monitor module 560, and the social networking services provide 665 any such messages. The social engagement server 140 determines, for each social engagement display controller 130 associated with it, which, if any, of those messages were posted by users currently checked in as attending an event or being at a location associated with that social engagement display controller. The social engagement server 140 then provides 670 those messages to that social engagement display controller 130, which displays 675 the messages on its associated displays 331.

At some later time, the social engagement server 140 may verify 680 that the posted messages have not been removed, as described above with respect to the rewards module 510, providing credit to the associated users if the messages are still posted.

Although FIG. 6 illustrates the various interactions occurring in a particular temporal sequence between given components, it is appreciated that the interactions could appear in different orders and between different components. For example, as noted, functionality of the social engagement server 140 and the social engagement display controller 130 may be apportioned differently than described above. For instance, the functionality of the social engagement display controller 130 could be implemented on the social engagement server 140, with the displays 131 being controlled remotely over the network 160. Similarly, the social engagement display controller 130 could perform much of the functionality of the social engagement server 140, such as directly performing the check 660 for new messages, rather than relying on the social engagement server to do so. One of skill in the art would recognize that many such variations are possible.

Thus, by stimulating additional social engagement about events or concepts associated therewith (e.g., movie characters) on the social networking services 120, components such as the social engagement display controller 130 and the social engagement server 140 generate additional interest in the events. Further, through use of the check-in codes, it can be verified with a high degree of confidence that those commenting on events were actually present at the events and thus have genuine knowledge, resulting in higher-quality dialogue about the events. Further, the use of check-in codes also allows the verification of user identities, enabling the creation of a rich store of information about the users who attend the events, who might otherwise be unknown.

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method performed by a social engagement server, the method comprising:
calling an event schedule API of a remote event provider to determine a movie showtime and a movie location for each of a plurality of movie showings;
for each showing of the plurality of movie showings:
generating a plurality of unique check-in codes;
generating a plurality of distinct validity periods corresponding to the plurality of unique check-in codes based at least in part on the movie showtime;
distributing the check-in codes and indications of the corresponding validity periods to remote social engagement display controllers located at the movie showings for public display on movie theater screens used for the movie showings;
receiving, from a user at a first time via a client device of the user, a message including a check-in code and an identifier of the user;
determining whether the check-in code matches a first one of the distributed check-in codes;
determining whether the first time is within the validity period corresponding to the first one of the distributed check-in codes; and
responsive to the check-in code matching the first one of the distributed check-in codes and the first time being within the validity period corresponding to the first one of the distributed check-in codes:
storing a determination that the user is present at the movie showing, and
crediting an account of the user on the social engagement server.

2. A computer-implemented method comprising:
distributing a check-in code for an event, and an indication of a corresponding validity period, to a social engagement display controller at a geographic location associated with the event, the social engagement display controller causing display of the check-in code on displays located proximate to the social engagement display controller;
receiving, from a user, a message including a check-in code;
determining whether the check-in code included in the message matches the distributed check-in code;
determining whether a time of sending of the message is within the validity period corresponding to the distributed check-in code; and
responsive to the check-in code included in the message matching the distributed check-in code and the first time being within the validity period corresponding to the distributed check-in code, storing a determination that the user is present at the event.

3. The computer-implemented method of claim 2, further comprising:
identifying the user based on a user identifier included in the message;
obtaining user information about the user from social networking services of the user; and
identifying characteristics of attendees at the event based at least in part on the obtained user information.

4. The computer-implemented method of claim 2, further comprising:
providing a discussion question associated with the event to the social engagement display controller for display on the displays; and
identifying, on an account of the user on a social networking service, a message posted in response to display of the discussion question on the displays.

5. The computer-implemented method of claim 2, further comprising:
receiving, along with the check-in code, location information indicating a location of a user when the check-in code was sent; and
comparing the location indicated by the location information with a known location of the event corresponding to the received check-in code;
wherein determining that the user is present at the event is responsive at least in part to the comparing.

6. The computer-implemented method of claim 2, further comprising:
identifying the user based on a user identifier included in the message;
querying social networking services to determine whether the user posted a message about the event corresponding to the received check-in code;
receiving a message posted by the user about the event from one of the social networking services;
determining that at least a given minimum amount of time has elapsed since the user posted the message; and
crediting an account of the user on a social engagement server responsive to determining that at least the given minimum amount of time has elapsed.

7. The computer-implemented method of claim 2, further comprising:
providing the user with an application that facilitates commenting on the event via social networking services;
determining a number of messages posted by the user on the social networking services using the application within a given time period; and
crediting an account of the user on a social engagement server only if the number of messages is less than a given maximum number of messages.

8. The computer-implemented method of claim 2, further comprising crediting an account of the user on a social engagement server responsive to storing the determination that the user is present at the event corresponding to the received check-in code.

9. The computer-implemented method of claim 2, further comprising:
receiving, from a second user, a request to create an account on the social engagement server;
examining attributes of accounts of the second user on social networking services to determine whether to grant the request to create the account.

10. A computer-readable storage medium storing executable computer program instructions comprising:
instructions for distributing, for each of a plurality of locations, a check-in code and an indication of a corresponding validity period to a remote social engagement display controller at the location, the social engagement display controller causing display of the check in code on displays located proximate to the social engagement display controller;
instructions for receiving a message including a check-in code from a user;
instructions for determining whether the check-in code matches a first one of the distributed check-in codes;
instructions for determining whether a time of sending of the message is within the validity period corresponding to the first one of the distributed check-in codes; and
instructions for, responsive to the check-in code matching the first one of the distributed check-in codes and the first time being within the validity period corresponding to the first one of the distributed check-in codes, storing a determination that the user is present at the event.

11. The computer-readable storage medium of claim 10, further comprising:
instructions for identifying the user based on a user identifier included in the message;
instructions for obtaining user information about the user from social networking services of the user; and
instructions for identifying characteristics of attendees at the event based at least in part on the obtained user information.

12. The computer-readable storage medium of claim 10, further comprising:
instructions for providing a discussion question associated with the event to the social engagement display controller for display on the displays; and
instructions for identifying, on an account of the user on a social networking service, a message posted in response to display of the discussion question on the displays.

13. The computer-readable storage medium of claim 10, further comprising:
instructions for receiving, along with the check-in code, location information indicating a location of a user when the check-in code was sent; and
instructions for comparing the location indicated by the location information with a known location of the event corresponding to the received check-in code;
wherein determining that the user is present at the event is responsive at least in part to the comparing.

14. The computer-readable storage medium of claim 10, further comprising:
instructions for identifying the user based on a user identifier included in the message;
instructions for querying social networking services to determine whether the user posted a message about the event corresponding to the received check-in code;
instructions for receiving a message posted by the user about the event from one of the social networking services;
instructions for determining that at least a given minimum amount of time has elapsed since the user posted the message; and
instructions for crediting an account of the user on a social engagement server responsive to determining that at least the given minimum amount of time has elapsed.

15. The computer-readable storage medium of claim 10, further comprising:
instructions for providing the user with an application that facilitates commenting on the event via social networking services;
instructions for determining a number of messages posted by the user on the social networking services using the application within a given time period; and
instructions for crediting an account of the user on a social engagement server only if the number of messages is less than a given maximum number of messages.

16. The computer-readable storage medium of claim 10, further comprising instructions for crediting an account of the user on a social engagement server responsive to storing the determination that the user is present at the event corresponding to the received check-in code.

17. The computer-readable storage medium of claim 10, further comprising:
instructions for receiving, from a second user, a request to create an account on the social engagement server;
instructions for examining attributes of accounts of the second user on social networking services to determine whether to grant the request to create the account.
